(19) United States
(12) Patent Application Publication
(10) Pub. No.: US 2013/0091859 A1
(43) Pub. Date: Apr. 18, 2013

(54) AUXILIARY POWER UNIT FLUID SYSTEM FLUID CONTROL

(71) Applicant: Omar I. Osorio, San Diego, CA (US)

(72) Inventor: Omar I. Osorio, San Diego, CA (US)

(21) Appl. No.: 13/274,508

(22) Filed: Oct. 17, 2011

(51) Int. Cl. F02C 6/04; F02C 9/00

(52) U.S. Cl. 60/784; 137/1

(57) ABSTRACT

An auxiliary power unit includes a turbomachine coupled to a generator. A flow path is arranged through the generator and is configured to provide fluid to the generator. A deprime valve is arranged in the flow path and is configured to pulse fluid flow to the generator in response to a command. A controller is configured to send the command to the deprime valve to pulse the fluid flow throughout operation of the auxiliary power unit.

### BACKGROUND

This disclosure relates to an auxiliary power unit (APU) fluid system fluid control device and method. The fluid system provides cooling and lubrication for various components of the APU.

Aircraft APUs, for example, typically include a generator that is driven by a turbomachine. The turbomachine typically is rotatably coupled to the generator through a gearbox. Fluid, such as oil, is circulated along a flow path through the gearbox and the generator. The fluid removes thermal energy and lubricates various components.

A deprime valve is typically arranged in the flow path to regulate fluid flow within the fluid system. In one type of control scheme, the valve is fully closed until the generator reaches 50% of its operating speed, after which the valve is fully opened. The valve is moved from closed to open once, which occurs during APU start up. The closed valve prevents fluid flow, while the open valve permits the fluid to be circulated through the fluid system.

### SUMMARY

An auxiliary power unit includes a turbomachine coupled to a generator. A flow path is arranged through the generator and is configured to provide fluid to the generator. A deprime valve is arranged in the flow path and is configured to pulse fluid flow to the generator in response to a command. A controller is configured to send the command to the deprime valve to pulse the fluid flow throughout operation of the auxiliary power unit.

### BRIEF DESCRIPTION OF THE DRAWINGS

The disclosure can be further understood by reference to the following detailed description when considered in connection with the accompanying drawings wherein:

FIG. 1 is a schematic view of an example auxiliary power unit and associated fluid path for cooling and lubrication.

### DETAILED DESCRIPTION

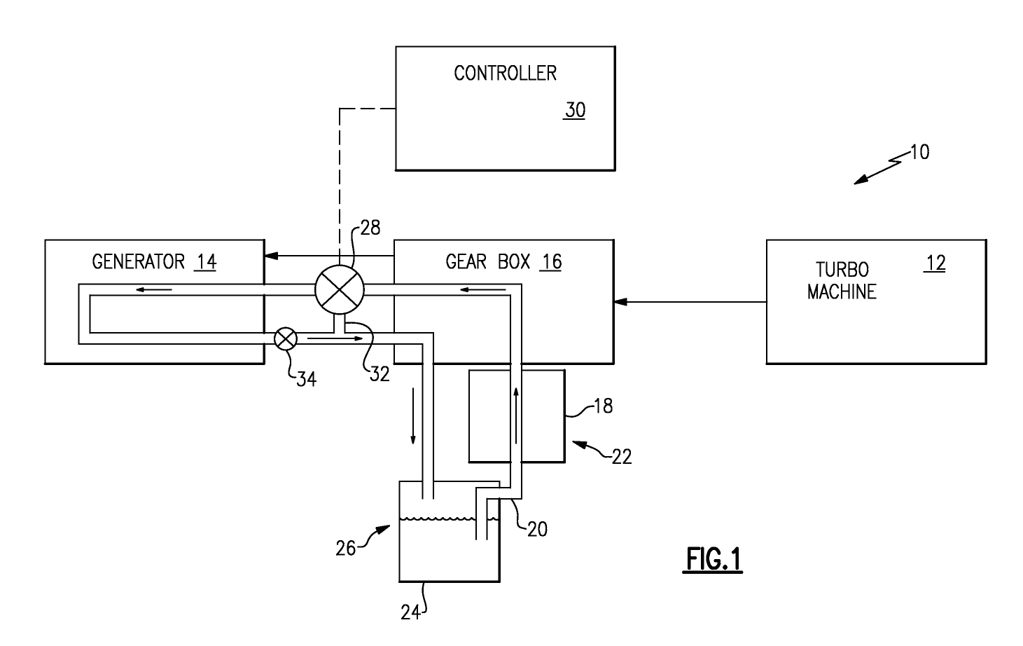

Referring to FIG. 1, an example auxiliary power unit (APU) 10 includes a turbomachine 12. The turbomachine 12 is rotatably coupled to a generator 14 through a gearbox 16. A pressurized fluid source 22, which includes a pump 18, for example, circulates a fluid throughout a fluid path 20. In one example, the fluid is a coolant, such as lubricating and cooling oil. The fluid cools and lubricates portions of the generator 14 and the gearbox 16. The fluid is circulated to a location 26, such as a sump 24 from which the pump 18 again draws the fluid for recirculation. It should be understood that the fluid system is exemplary and other circulation configurations may be used.

A deprime valve 28 is arranged in the fluid path 20 for selectively regulating fluid flow to the generator 14. If too much fluid is provided to generator 14 or fluid is provided too soon during start up, then the generator will undesirably drag and slow down the APU 10. Alternatively or additionally, the deprime valve 28 may be positioned to regulate fluid flow to the gearbox 16.

The deprime valve 28 is movable between closed and open positions. The closed valve prevents fluid flow, while the open valve permits the fluid to be circulated through the fluid system. The deprime valve 28 may also be moved to a position between the open and closed positions. A return line 32 fluidly connects the deprime valve 28, when closed, to another location along the flow path 20, for example. A check valve 34, for example, can be positioned to prevent fluid flow to the generator 14 when the deprime valve 28 is closed, ensuring the fluid bypasses the generator 14.

A controller 30 communicates with the deprime valve 28 to selectively regulate the flow of fluid through the flow path 20. In one example, the controller 30 sends a command to the deprime valve 28 to continuously pulse or modulate the valve between positions, such as the open and closed positions, throughout operation of the APU 10 and not simply at start up. However, the deprime valve 28 is not required to pulse during the entire operating time of the APU 10.

The deprime valve 28 is modulated regardless of fluid temperature. That is, the deprime valve is not simply moved from closed to open once a predetermined fluid temperature is reached. However, the deprime valve 28 may be modulated differently based upon temperature, for example, more quickly at low temperatures and more rapidly as the fluid temperature increases. In this manner, the generator 14 is not flooded with fluid, which would cause drag. The deprime valve 28 is controlled by the engine controller or Full Authority Digital Engine Controller, for example. When energized, the deprime valve 28 prevents oil from circulating in the APU 10, such that the oil flows back to the sump 24. As a result, the drag on the APU 10 is reduced since the pump 18 does not have to create oil system pressure.

It should be noted that the controller 30 is used to implement various functionality disclosed in this disclosure. In terms of hardware architecture, such a controller can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor may be a hardware device for executing software, particularly software stored in memory. The processor can be a custom made or commercially available processor, a central processing unit (CPU), an auxiliary processor among several processors associated with the controller, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

When the controller is in operation, the processor can be configured to execute software stored within the memory, to communicate data to and from the memory, and to generally control operations of the controller pursuant to the software. Software in memory, in whole or in part, is read by the processor, perhaps buffered within the processor, and then executed.

Although an example embodiment has been disclosed, a worker of ordinary skill in this art would recognize that certain modifications would come within the scope of the claims. For that reason, the following claims should be studied to determine their true scope and content.

What is claimed is:

1. An auxiliary power unit comprising:
a turbomachine coupled to a generator;
a flow path through the generator configured to provide fluid to the generator;
a deprime valve arranged in the flow path and configured to pulse fluid flow to the generator in response to a command; and
a controller configured to send the command to the deprime valve to pulse the fluid flow throughout operation of the auxiliary power unit.

2. The auxiliary power unit according to claim 1, comprising a gearbox coupling the turbomachine and the generator, the gearbox arranged in the flow path.

3. The auxiliary power unit according to claim 1, comprising a pump and a sump arranged in the flow path, the deprime valve arranged downstream from the pump.

4. The auxiliary power unit according to claim 3, comprising a return line fluidly connecting the deprime valve to another location in the flow path to bypass the generator with the deprime valve in the closed position.

5. A method of regulating fluid flow in an auxiliary power unit flow path, comprising:
pulsing a deprime valve arranged in a fluid flow path that is in communication with a generator; and
selectively regulating the flow of fluid to the generator throughout operation of the auxiliary power unit.
